(19) United States
(12) Patent Application Publication
(10) Pub. No.: US 2014/0372717 A1
(43) Pub. Date: Dec. 18, 2014

(54) Fast and Secure Virtual Machine Memory Checkpointing

(71) Applicant: Microsoft Corporation, Redmond, WA (US)

(72) Inventors: Weidong Ciu, Redmond, WA (US); Marcus Peinado, Bellevue, WA (US); Chengyu Song, Atlanta, GA (US)

(21) Appl. No.: 13/921,156

(22) Filed: Jun. 18, 2013

(51) Int. Cl. G06F 3/06

(52) U.S. Cl. CPC G06F 3/065; G06F 3/0614; G06F 3/0673
USPC 711/162

(57) ABSTRACT

Aspects of the subject disclosure are directed towards efficiently and securely capturing virtual machine memory checkpoints via a post-copy scheme that runs outside of the virtual machines. To reduce the volume of data that has to be captured a dictionary of cryptographic hashes of pages captured in previous checkpoints is used, so that pages already in the dictionary may be represented by the hash value in the current checkpoint. Further, unused memory is identified by leveraging virtual machine introspection techniques outside the virtual machine to walk guest process lists and page tables.

### BACKGROUND

In cloud computing, a significant amount of computation is performed on virtual machines (VMs). As with a physical machine, various attacks can compromise the integrity of virtual machines, and thus monitoring needs to be done.

Similar to network security monitoring, virtual machine monitoring can be active or passive. Active monitors, such as commercial anti-virus systems, detect and prevent known attacks in real time (e.g., by scanning files as they are opened), and thus impact system performance. Passive monitoring aims to detect rather than prevent attacks and has no inherent real time constraint. Passive monitoring operates in general by using a consistent memory capture technique, also known as a (memory) snapshot or a (memory) checkpoint, and performing a thorough offline analysis (deep inspection) on the checkpoint to detect compromises.

Consistent memory capture refers to the memory being captured at a single instant in time. However, it is highly undesirable to stop a virtual machine for a long period of time to capture the memory contents to disk or via a network connection; at the same time, having additional RAM reserved just for memory checkpointing wastes too many resources to be practical. Thus, known techniques exist that allow the virtual machine to run while the memory contents are being copied out to a relatively slow storage.

The consistent memory capture process consumes resources, and thus also impacts a running virtual machine, whereby efficient capture is highly desirable. However, existing capturing techniques, which need to operate with limited resources, are not particularly secure or performant.

For example, a well-known “pre-copy” algorithm performs initial copying, tracks dirtied pages during the copy and recopies (possibly multiple times) only the pages dirtied during the previous copy, until the amount of dirtied is small. The machine is then suspended to copy this final dirtied memory, until a consistent captured checkpoint state is achieved at the end of the copying process. However such copying activities can be detected by malware, which can then take defensive/evasive actions (enter a stealth mode) to avoid detection.

A known “post-copy” algorithm briefly stops a virtual machine to write-protect its pages and then begins copying memory from that point in time, removing write protection for a page once copied. Any protected page that is written to results in a page fault, which triggers a copy of the page before the write protection is then removed so the page can be written. This algorithm is not detectable to malware, but is not very performant, as in practice, page faults often suspend a virtual machine on the order of thousands of times/tens of seconds in total.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards capturing checkpoint data for passive monitoring of memory content in a post-copy checkpointing operation, in which the checkpoint data is captured with a reduced amount of data copying. In one or more aspects, a determination is made as to whether a page of content to checkpoint already exists in another passive monitoring storage location (e.g., a dictionary). If so, the page of content is represented in the checkpoint data via an identifier (e.g., a hash of the content). If not, the page of content is copied from memory to the checkpoint data.

In one aspect, a hypervisor is configured to manage virtual machines. Passive monitoring logic incorporated into or coupled to the hypervisor captures virtual machine memory state in an online post-copy checkpointing operation, including representing content already in a dictionary by a hash value of that content that is written to checkpoint data. Content not already in the dictionary is copied to the checkpoint data.

One or more aspects are directed towards determining a subset of memory pages in currently in use relative to a checkpoint time, including by walking page table data of a virtual machine via a mechanism outside of the virtual machine. The subset is checkpointed, including capturing data corresponding to the subset of memory pages in a post-copy checkpointing operation.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for checkpointing virtual machine memory for passive monitoring via a reduced amount of copying, according to one or more example implementations.

FIG. 2 is a flow diagram representing example steps that may be taken to reduce copying while checkpointing via a hash-based content identification scheme, according to one or more example implementations

FIGS. 3 and 4 comprise a flow diagram representing example steps that may be taken to reduce copying while checkpointing by determining which pages are in use and which are unused, according to one or more example implementations

FIG. 5 is a block diagram representing example non-limiting networked environments in which various embodiments described herein can be implemented.

FIG. 6 is a block diagram representing an example non-limiting computing system or operating environment in which one or more aspects of various embodiments described herein can be implemented.

### DETAILED DESCRIPTION

Various aspects of the technology described herein are generally directed towards secure memory checkpointing based upon a post-copy scheme that runs outside of a virtual machine. In one aspect, memory checkpointing as described herein operates relatively fast by reducing the volume of data that has to be captured. Note that in general, the terms “checkpoint” and “snapshot” and their derivatives, (e.g., “checkpointing”) may be used interchangeably herein.

In one implementation, memory that can be omitted from the checkpoint is identified by its content, e.g., by maintaining a dictionary of cryptographic hashes of pages captured in previous checkpoints, and omitting those pages already in the dictionary from copying into the current checkpoint. Note that previous solutions identify memory pages that have not changed from the previous checkpoint by tracking either the dirty bits in the page tables or disk I/O. However, this means there is overhead during regular operation, e.g., when no checkpoint is being taken, and further, considers the same content as dirty if its content page is swapped out of memory and back into memory.

In one aspect, the secure memory checkpointing technology described herein also may identify unused memory without relying on code inside the virtual machine, by leveraging virtual machine introspection techniques. In general, this is accomplished by walking guest process lists and/or page tables. Once identified, such unused memory need not be copied.

It should be understood that any of the examples herein are non-limiting. For example, virtual machines are exemplified as being passively monitored, however the technology described herein is not limited to virtual machine environments. As another example, Windows® operating system-based examples are used herein, but the technology described herein is not limited to Windows® operating systems. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and secure monitoring in general.

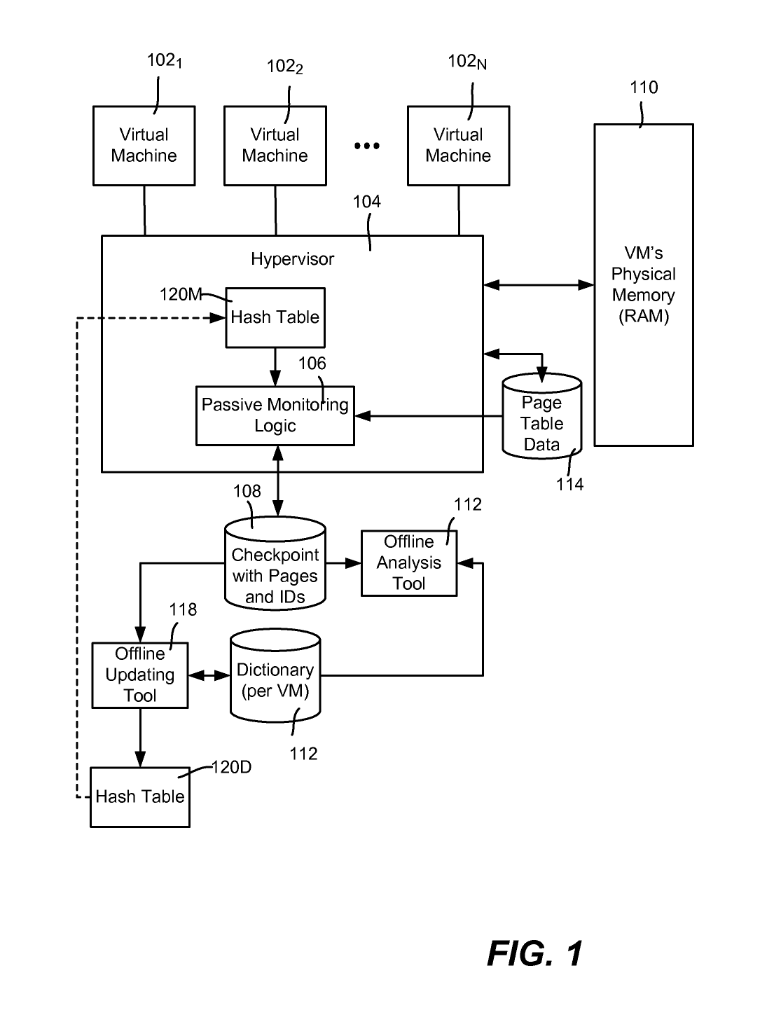

FIG. 1 shows a generalized block diagram in which a plurality of virtual machines 102₁-102_{N} are managed by a hypervisor 104. As described herein, the hypervisor 104 includes passive monitoring logic 106 that uses one or more techniques to efficiently capture a checkpoint 108 from a virtual machine's guest operating system's locations in their memory 110. Note that the hypervisor 104 and the passive monitoring logic 106 are understood to be in memory, as well as the data accessed thereby, however for purposes of explanation in FIG. 1 the block surrounding the hypervisor 104 is shown as containing the passive monitoring logic 106 and its data.

The checkpoint 108/checkpoint data may be maintained in a single data structure or any combination of data structures. For example, the checkpoint may represent the captured memory state via a mix of hash identifiers and actual (e.g., possibly compressed) content. Alternatively, the checkpoint may comprise a data structure of hash identifiers and another data structure of copied page content, with a mechanism that tracks how the original pages may be reassembled in the proper order from the data structures. Other arrangements are feasible.

As will be understood, in one or more implementations, capturing the checkpoint 108 may efficiently accomplished by the use of content identifiers (e.g., hash values) that represent the page content, rather than the content itself where possible. For example, a data store comprising cryptographic hash values and the corresponding content, referred to as a dictionary 112, may be maintained, so as to avoid copying a memory page (or other unit) that is already known to exist, thereby reducing overall copying time.

Further, copying of unused memory may be avoided by accessing page table data 114 so that pages that are unused need not be copied, thereby reducing overall copying time. Moreover, the pages may be divided into kernel and user mode pages, for example, for further reduction in copying such as by only copying the subset of pages that are both used and potentially contain malware.

The result is a checkpoint 108 containing a mix of copied page data and identifiers of already seen content, in which the number of copied pages may be reduced by only copying pages in use at the time of the capture, (and optionally only a smaller subset of those, e.g., kernel pages). An offline analysis tool 116 thus can reassemble the original memory contents that are relevant for performing offline analysis.

The passive monitoring logic checks for memory pages that have already been seen in a previous checkpoint. More particularly, “temporal memory similarity” refers to the fact that some memory pages of long running processes as well as the operating system kernel may not change frequently over time. For example, consider a snapshot stored as a list of 64-bit hash values, each of which represents a 4 KB physical memory page. In practice, the monitoring logic will find between one-fifth and one-third of its memory pages unchanged between two snapshots captured a week apart. Note that as used herein with respect to capturing pieces of data to checkpoint, the term “page” is used herein, but it is understood that a captured page is not limited to any physical page size, e.g., two 4K physical pages in memory may be captured as one captured page during the checkpointing process, as can a 2K (half a physical) page of data.

Indeed, the monitoring logic can leverage memory similarity at different space granularity. For example, while 4 KB physical memory pages may be used because paging is performed mainly at this level (except for some large pages), larger or smaller size units may be used. The advantage of choosing a smaller granularity is that there are more hash value matches, however data compression has a lower compression ratio when the size of the input data is smaller.

The monitoring logic 106 cannot grow the dictionary 112 without bounds, and thus a user-provided memory budget may be used to control the number of hashes that are used during memory capture. When the monitoring logic 106 uses up the budget, an eviction policy such as first-in, first-out (FIFO) may be used to evict hashes from the dictionary 112. For example, each hash is associated with a timestamp that is refreshed when the hash appears in a new checkpoint.

Note that monitoring logic 106 manages the disk budget indirectly, as the dictionary only need be accessed offline. For each memory page in the dictionary 112, a reference count may be used to track the number of existing checkpoints in which the memory page appears. A memory page is removed from the dictionary 112 if the user chooses to delete the memory snapshots that contain it and if its hash was also evicted from the dictionary 112.

An offline updating tool 118 keeps copies of memory pages from previous memory snapshots in the dictionary 112; there may be one such dictionary for each virtual machine. In the dictionary 112, for each unique memory page the offline updating tool 118 stores a copy of the data and the cryptographic hash of its data contents. Note that the memory copies are only stored on disk because they are only used during offline analysis 112.

Turning to online memory capture, the hashes may be loaded into memory for fast lookup. In one implementation, the passive monitoring logic 106 comprises a copy-on-write, post-copy memory capture algorithm that uses a cryptographic hash (e.g., SHA-1) to compute a unique hash for each distinct set of memory page content, in a way that avoids collision. In one implementation, the unique hashes are stored in a hash table, (e.g., a cuckoo hash table) shown in FIG. 1 as 120D when on disk, or 120M when copied into memory. To speed up the loading of the hash table, the whole table may be stored on disk such that it may be mapped directly into memory directly without any table construction overhead. Multiple (e.g., three) hash functions may be used in the hashing scheme.

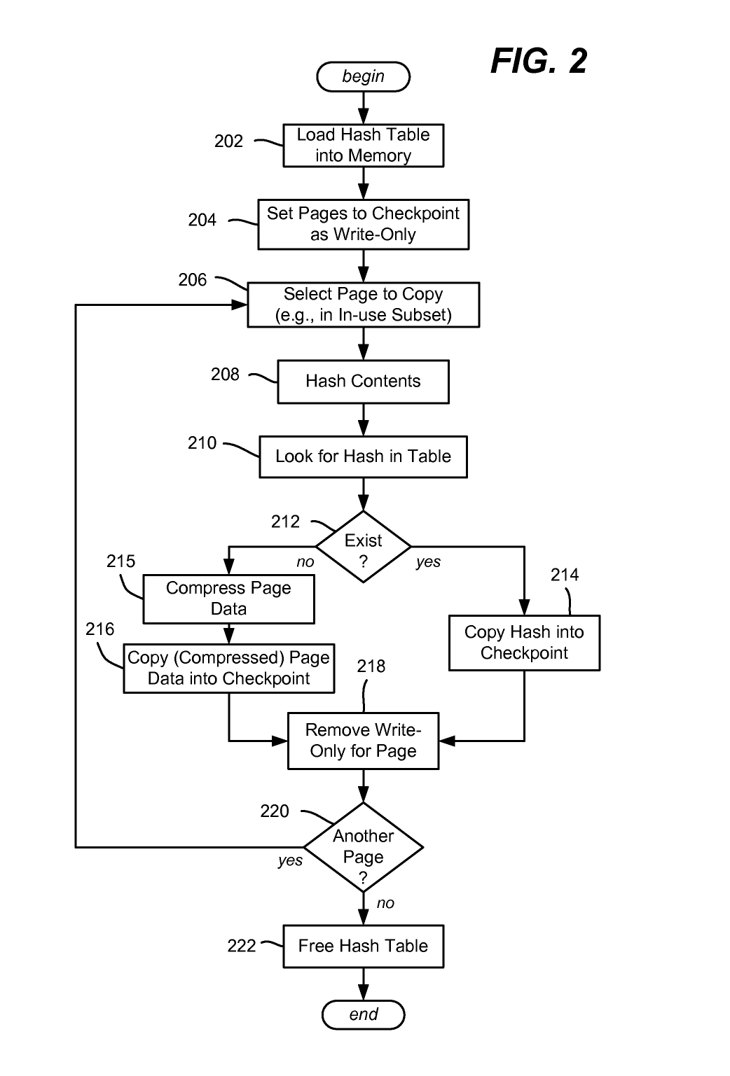

As generally represented in FIG. 2, the hash table 120M is loaded into memory (step 202) when a memory capture of a virtual machine starts, but before that virtual machine is suspended to make memory pages copy-on-write (step 204). In one implementation, when copying memory to a snapshot file on multiple threads, the hash table 120M is used only for lookup to avoid the overhead of synchronization. After the memory capture is finished, the hash table 120D is updated offline to insert new hashes. The memory copies in the dictionary 112 are also updated offline, and may be compressed to save space.

Via steps 206 and 220, for each memory page from the virtual machine being captured, the monitoring logic 106 checks whether its cryptographic hash exists. To this end, step 208 represents hashing the page contents, and step 210 represents looking for the hash in the hash table. If the hash exists (step 212), the monitoring logic 106 saves the cryptographic hash in the checkpoint 108 at step 214. If not, the page data is saved in the checkpoint 108 at step 216. In one implementation, the page data is compressed before it is saved in the checkpoint (optional step 215). As can be readily appreciated, the resource savings from the reduced amount of data to checkpoint significantly outweigh the cost of the hash computations and table lookup.

One a page has been processed, that page may have its read-only protection removed at step 218. Step 220 repeats for other pages. After a memory checkpoint 108 is taken, hash table space may be reclaimed (step 222).

As set forth above, for fast operation, the hash table is only used for a lookup during online operation in one implementation. For subsequent uses, the offline updating tool 118 processes the checkpoint to update the hash table 120D offline, as well as update the dictionary 112 by adding new unique hashes and corresponding pages found in the latest checkpoint 108.

Turning to another aspect, unused memory need not be captured. For example, at the moment the snapshot is taken, the guest OS may not be actively using all of its available memory. By identifying the unused memory pages and omitting them from the checkpoint, the memory capture process is sped up. However, it should be noted that detecting unused pages by deploying a balloon driver is not secure, because the balloon driver is inside the virtual machine.

For security monitoring, one or more solutions described herein recognize unused memory from outside of the virtual machine. In one aspect, the monitoring logic 106 uses virtual machine introspection (VMI) to understand a virtual machine's running state and identify unused memory.

One approach to inferring unused memory is to traverse the data structures of the guest operating system's memory manager to find unused memory, as the memory manager tracks what guest physical memory pages are not being used. This is one suitable alternative.

Alternatively, the monitoring logic 106 may traverse the guest page tables to find the guest physical pages that are currently mapped, whereby any other unmapped guest physical pages are treated as unused. This approach requires finding the processes in the guest operating system, and the base addresses of their respective page tables.

The latter approach benefits from the data structures for processes being well-known (e.g., public for the Windows® operating system) and stable. The structure and semantics of page tables are also well defined. In contrast, the memory manager's data structures are private for Windows® and may change between operating system releases, e.g., for performance improvements. Further, finding the processes in the guest operating system and traversing their page tables, the monitoring logic 106 can also support partial memory snapshots as described herein.

More particularly, depending on the application for which the memory is being captured, a smaller part of the virtual machine's memory may be captured. For example, if a scenario is to scan the kernel memory for malware detection, it is sufficient to capture only the memory used by kernel mode modules. For 32/64-bit Windows® and 64-bit Linux® operating systems, the top half of the virtual address space is reserved for kernel memory. For 32-bit Linux® operating systems, the top fourth of the virtual address space is reserved for kernel memory. Therefore the monitoring logic can identify the kernel memory by walking the top half or top fourth of the page tables. Similarly, it may only be necessary to save the memory used by a particular process. In this scenario, the monitoring logic finds the process and then traverses the user mode part of its page tables to find the memory pages to save.

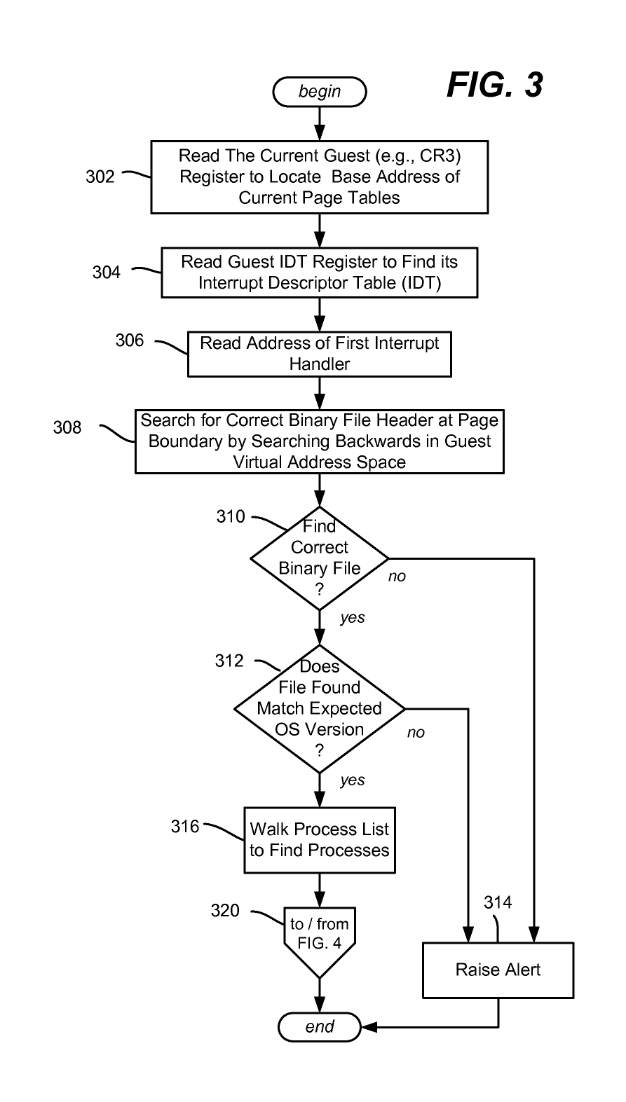

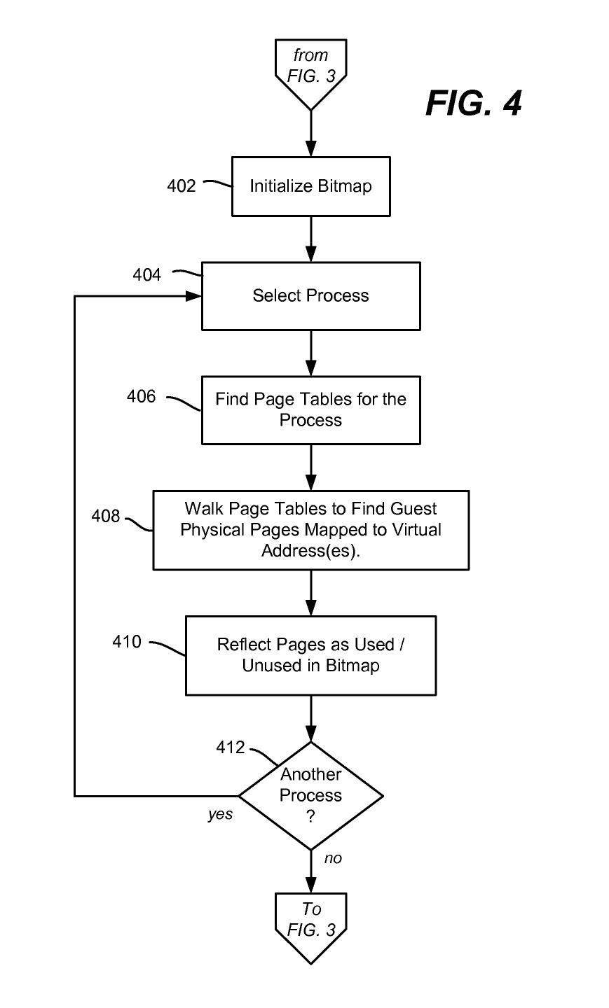

To identify unused memory, as generally represented in FIGS. 3 and 4, the monitoring logic 106 enumerates processes in the guest operating system and walks their page tables by using virtual machine introspection (VMI) techniques. At step 302, the monitoring logic 106 reads the current guest (e.g., CR3) register to locate the base address of the current page tables. The monitoring logic 106 uses the current page tables to translate guest virtual addresses to guest physical addresses and uses Hypervisor APIs to read guest physical memory.

The monitoring logic locates the kernel image in the guest operating system as represented via steps 304, 306 and 308. To this end, step 304 reads the guest IDT register to find its interrupt descriptor table, and step 306 reads the address of the first interrupt handler (division by zero), which falls in the middle of the kernel image if the guest operating system is not compromised. Step 308 searches for a correct binary file header at the page boundary by searching backwards in the guest virtual address space. If the monitoring logic fails to find a correct binary file (step 310) or the file found does not match the expected OS version (step 312), the monitoring logic raises an alert (step 314).

After locating the kernel image, as represented by step 316, the monitoring logic walks the process list to find the processes (i.e., EPROCESS instances on Windows® configurations). By way of example, in Windows®, the process list is a doubly linked list that starts at PsActiveProcessHead and links EPROCESS data structures at the ActiveProcessLinks field. The monitoring logic looks up the symbols to find the offset of PsActiveProcessHead in the kernel image and the offset of field ActiveProcessLinks in the EPROCESS data structure. The base address of a process' page tables is stored in the field DirectoryTableBase in the EPROCESS data structure.

For fast look up of unused pages (e.g., when selecting a page to copy at step 206 of FIG. 2), the monitoring logic stores the used/unused information in a bitmap. Step 402 represents initializing the bitmap.

As represented in FIG. 4 via steps 404 to 412, the logic finds and walks each process' page tables to find guest physical pages that are mapped to some virtual address(es) (steps 406 and 408). Then the monitoring logic treats unmapped physical pages as unused in the bitmap (step 410).

In addition to full memory captures, the monitoring logic supports partial memory captures. Because the kernel part of the address space is shared among the processes, the monitoring logic traverses the current guest page tables to identify memory pages mapped into the kernel address space. This provides a kernel-only memory capture that can be used by kernel memory scanning tools. Note that such a memory capture only contains the session space memory for the current session, however it is straightforward to capture memory of any or all sessions in a kernel-only memory capture because, for example, the EPROCESS data structure contains information about a process' session.

For example, for a process-specific memory capture in a Windows® implementation, the monitoring logic traverses the process list to find the EPROCESS instance for the requested process. The monitoring logic then walks its page tables to find memory pages mapped into the process's user address space.

In one implementation, the monitoring logic is integrated into the hypervisor to leverage the basic functionality provided by the hypervisor (e.g., read guest physical memory and CPU state) and to compare it with the hypervisor's current memory snapshot scheme. Note that during initialization, hypervisor write-protects all guest physical pages. To speed up this initial procedure and avoid unnecessary page faults during memory copy, the hypervisor may be modified to only write-protect the guest physical pages that are mapped.

During memory copy, the hypervisor reads a memory page into a buffer, compresses the buffer and writes it to a memory capture file. The monitoring logic described herein fills the buffer with zeros if the memory page is unused. This saves a system call for a guest memory read, and also allows the page be compressed to eight bytes. The monitoring logic also may provide compression code that leverages temporal memory similarity. For example, if a memory page is not filled with an eight-byte constant, the monitoring logic computes its SHA-1 hash and checks if it is in the hash table of known SHA-1 hashes. If so, the monitoring logic uses the SHA-1 hash to represent the memory page and writes the hash to the memory capture file. If not, the monitoring logic use the existing compression code to compress the memory page and write the compressed data to the memory capture file.

The post-copy approach along with using virtual machine introspection avoids giving indications to malware that a memory capture is about to take place. However, malware may still be able to anticipate memory captures if the captures take place at predictable times. This problem can be avoided by setting the memory capture times randomly. Attackers thus have no way to prepare or plan for evading memory capture.

Another possible evasion scheme by malware is to exploit the detection of unused memory. If malware inside a virtual machine can trick the monitoring logic to treat its memory pages as unused, the malware can evade the memory capture. To have a memory page be detected as unused, one of two conditions need to be met, namely that the page tables where the memory page is mapped are hidden, or the memory page is unmapped when the memory capture happens. Because the malware cannot predict or detect when the memory will be captured, the malware cannot reliably satisfy the second condition.

To hide the page tables to meet the first condition, the malware has to hide the process data structure from the process list that the monitoring logic walks to find the processes. However, the monitoring logic can detect hidden processes by analyzing the captured memory. There are well-known and deployed techniques for detecting hidden processes (e.g., traverse the active thread list to find processes). Furthermore, the monitoring logic can use existing kernel rootkit detection tools to detect hidden processes. Thus, as long as the malware is resident in memory when the memory is captured, the malware is detectable.

As can be seen, by identifying memory pages by their content, content identifiers (e.g., cryptographic hashes) may be used to represent known content in checkpoints rather than the corresponding page data. This requires no extra overhead during normal (non-capturing) virtual machine operation. Further, monitoring is done entirely outside the virtual machine, by leveraging virtual machine introspection techniques to perform the capture, including walking guest page tables.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

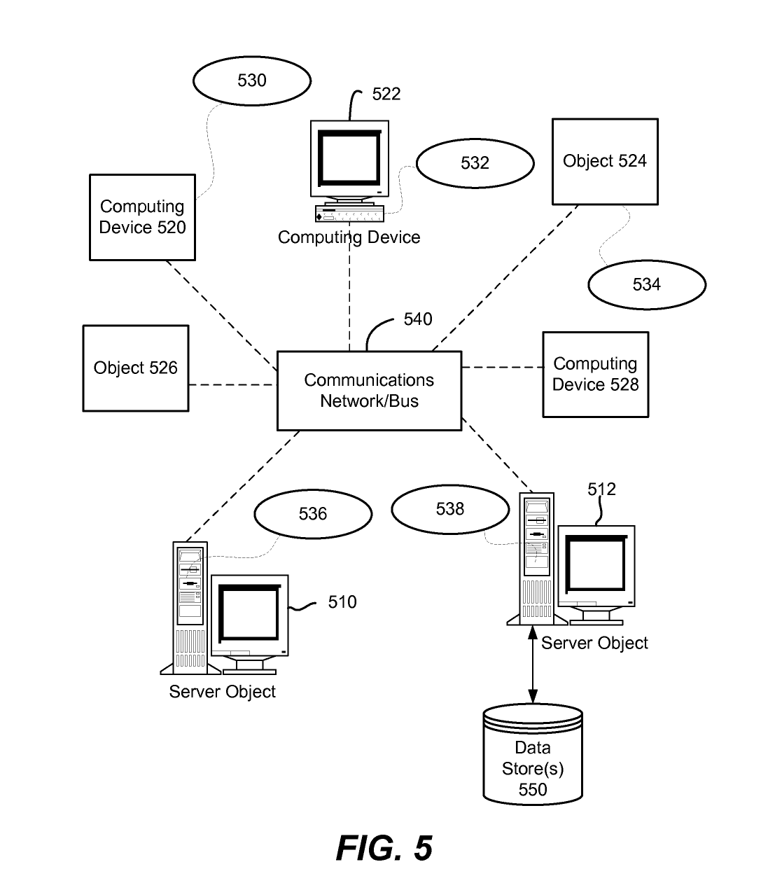

FIG. 5 provides a schematic diagram of an example networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Example Computing Device

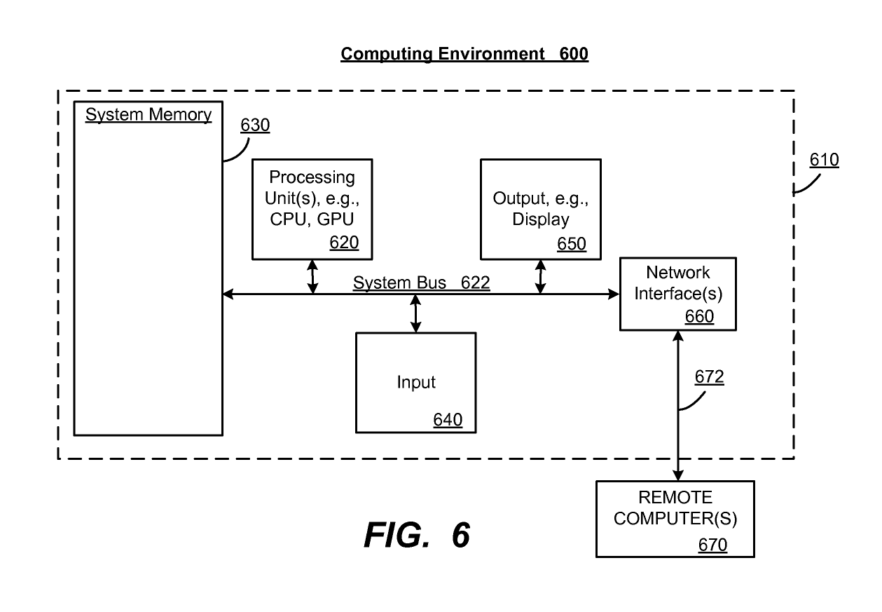

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the example computing system environment 600.

With reference to FIG. 6, an example remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. A method comprising, capturing checkpoint data for passive monitoring of memory content in a post-copy checkpointing operation, including determining whether a page of content to checkpoint already exists in another passive monitoring storage location, and if so, representing that page of content in the checkpoint data via an identifier, and if not, copying the page of content from memory to the checkpoint data.

2. The method of claim 1 wherein determining whether the page of content to checkpoint already exists in the other storage location comprises hashing the page of content into the identifier, and looking up whether the identifier exists in a data structure that indicates which pages of content are in the other storage location.

3. The method of claim 2 further comprising processing the checkpoint data to update the data structure.

4. The method of claim 1 further comprising processing the checkpoint data to update a dictionary corresponding to the other storage location, in which the dictionary includes data corresponding to pages of content as indexed by identifiers.

5. The method of claim 1 further comprising, selecting the page of content to checkpoint, including determining whether the page is identified as part of a subset of pages to checkpoint.

6. The method of claim 5 further comprising, determining the subset, including determining which pages are in use at a time corresponding to the checkpointing post-copy time.

7. The method of claim 6 wherein determining which pages are in use comprises walking page tables of processes.

8. The method of claim 6 further comprising, representing whether each page is used or unused in a data structure for use in determining whether the page is identified as part of the subset of pages to checkpoint.

9. The method of claim 5 further comprising, determining the subset based upon selecting only specified memory pages for the subset.

10. The method of claim 5 further comprising, determining the subset based upon selecting only kernel memory pages for the subset.

11. The method of claim 5 further comprising, determining the subset, including determining from among only kernel pages which kernel pages are in use at a time corresponding to the checkpointing post-copy time.

12. A system comprising, a hypervisor configured to manage virtual machines, and passive monitoring logic incorporated into or coupled to the hypervisor, the passive monitoring logic configured to capture virtual machine memory state in an online post-copy checkpointing operation, including to represent content already in a dictionary by a hash value of that content that is written to checkpoint data, and to copy content not already in the dictionary to the checkpoint data.

13. The system of claim 12 further comprising an offline tool that updates the dictionary based upon the checkpoint data.

14. The system of claim 12 wherein the passive monitoring logic is further configured to walk page table data to determine which pages of content are in use to exclude pages not in use from the checkpointing operation.

15. The system of claim 12 wherein the passive monitoring logic is further configured to walk page table data of processes to determine which pages of content are in use.

16. The system of claim 12 wherein the passive monitoring logic is configured to determine whether the content is already in the dictionary by accessing a data structure of hash values of content already in the dictionary.

17. The system of claim 12 wherein the data structure comprises a hash table.

18. One or more computer-readable storage media or logic having computer-executable instructions, which when executed perform steps, comprising, determining a subset of memory pages in currently in use relative to a checkpoint time, including by walking page table data of a virtual machine via a mechanism outside of the virtual machine, and checkpointing the subset, including capturing data corresponding to the subset of memory pages in a post copy checkpointing operation.

19. The one or more computer-readable storage media or logic of claim 18 wherein walking the page table data comprises walking tables of processes.

20. The one or more computer-readable storage media or logic of claim 18 having further computer-executable instructions comprising, determining whether a page of the subset is already maintained in a dictionary with an associated identifier, and if so, checkpointing the page into checkpoint data by representing the page via a corresponding identifier in the checkpoint data.
